(19) United States
(12) Patent Application Publication
(10) Pub. No.: US 2007/0057752 A1
(43) Pub. Date: Mar. 15, 2007

(54) Heat actuated magnetic latching microswitch

(76) Inventor: Youfa Wang, Loveland, CO (US)

Correspondence Address: AVAGO TECHNOLOGIES, LTD., P.O. BOX 1920, DENVER, CO, 80201-1920, US

(21) Appl. No.: 11/227,756

(22) Filed: Sep. 15, 2005

(51) Int. Cl. H01H 77/04

(52) U.S. Cl. 335/37

(57) ABSTRACT

A heat actuated switch comprises a substrate, a moveable element having at least one electrical contact associated therewith, a permanent magnet in the vicinity of the electrical contact, a ferromagnetic material in the vicinity of the permanent magnet and associated with the at least one electrical contact, and a heater adjacent the ferromagnetic material, whereby actuating the heater alters the magnetic properties of the ferromagnetic material and causes the moveable element to switch the electrical contact.

### BACKGROUND

Many different technologies have been developed for implementing micro electromechanical systems (MEMS) radio frequency (RF) switches. These technologies include, for example, magnetically driven MEMS RF switches, electrostatically driven MEMS RF switches, thermal expansion MEMS RF switches and liquid metal microswitches. These technologies all have disadvantages. For example, magnetically driven MEMS RF switches require high drive power, on the order of 100-300 milliwatts (mW), electrostatically driven MEMS RF switches require high drive voltage, on the order of 48 volts (V), and produce unwanted RF signal components, thermal expansion MEMS RF switches require high drive power and are unable to latch, and liquid metal microswitches are difficult to manufacture. In addition, existing MEMS microswitches suffer from stiction. Stiction is an informal contraction of the term static friction. Stiction occurs when surface adhesion forces are higher than the mechanical restoring force of the microswitch. Stiction refers to the reluctance of the contacts to separate when switching is desired.

Therefore, it would be desirable to have a microswitch capable of switching RF signals and that overcomes these deficiencies.

### SUMMARY OF THE INVENTION

A heat actuated switch comprises a substrate, a moveable element having at least one electrical contact associated therewith, a permanent magnet in the vicinity of the electrical contact, a ferromagnetic material in the vicinity of the permanent magnet and associated with the at least one electrical contact, and a heater adjacent the ferromagnetic material, whereby actuating the heater alters the magnetic properties of the ferromagnetic material and causes the moveable element to switch the electrical contact.

A method for operating a heat actuated switch comprises latching a heat actuated switch in a first position, heating a first ferromagnetic material to a temperature at which the first ferromagnetic material becomes non-magnetic, and attracting a second ferromagnetic material using a permanent magnet to cause the switch to latch in a second position.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a schematic diagram illustrating a heat actuated magnetic latching microswitch in accordance with an embodiment of the invention.

FIG. 1B is a schematic diagram of the heat actuated microswitch of FIG. 1A after transitioning from a first position to a second position.

FIG. 2A is a schematic diagram illustrating a heat actuated magnetic latching microswitch in accordance with an alternative embodiment of the invention.

FIG. 2B is a schematic diagram of the heat actuated microswitch of FIG. 2A after transitioning from a first position to a second position.

FIG. 3A is a schematic diagram illustrating a heat actuated magnetic latching microswitch in accordance with another alternative embodiment of the invention.

FIG. 3B is a schematic diagram of the heat actuated microswitch of FIG. 3A after transitioning from a first position to a second position.

FIG. 4A is a schematic diagram illustrating a heat actuated magnetic latching microswitch in accordance with another alternative embodiment of the invention.

FIG. 4B is a schematic diagram of the heat actuated microswitch of FIG. 4A after transitioning from a first position to a second position.

FIG. 5 is a flowchart describing an exemplary method of operating a heat activated microswitch in accordance with an embodiment of the invention.

### DETAILED DESCRIPTION OF THE INVENTION

Embodiments of the heat actuated magnetic latching microswitch to be described below will be referred to as a heat actuated microswitch. The heat actuated microswitch can be fabricated using micro electromechanical systems technologies known to those skilled in the art. Accordingly, details of the fabrication and assembly of the heat actuated microswitch have been omitted.

The heat activated microswitch is based on the realization that once a ferromagnetic material reaches its Curie temperature, the ferromagnetic material will no longer be magnetized and will therefore no longer be attracted to a magnet. At a temperature above the Curie temperature, the ferromagnetic material is said to exhibit a paramagnetic characteristic. By controlling the temperature of a ferromagnetic material, the heat actuated microswitch to be described below can be rapidly switched between states.

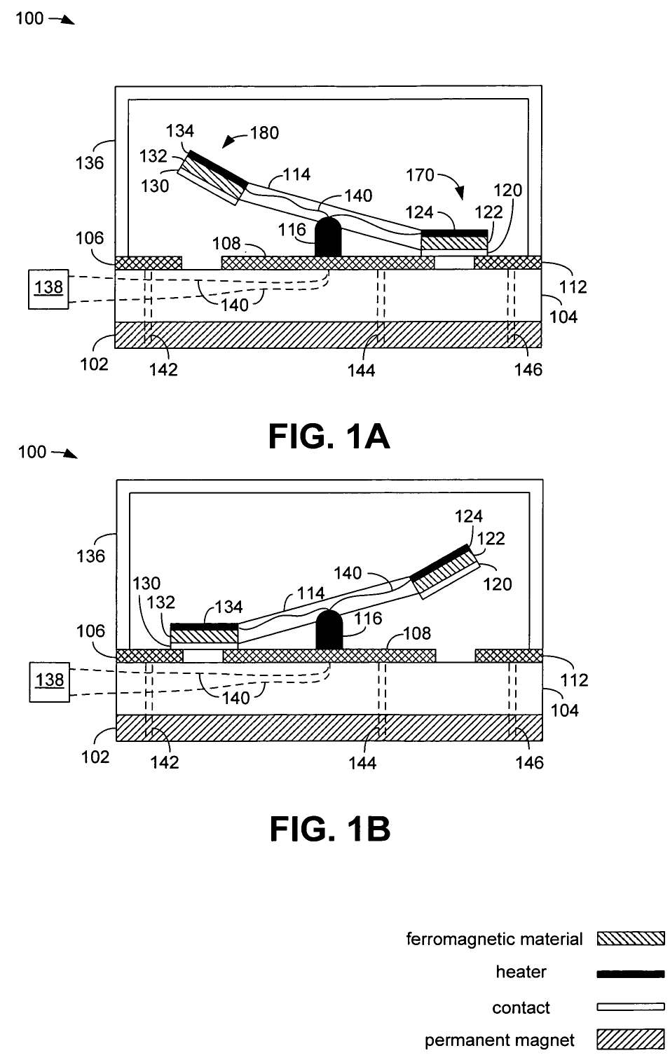

FIG. 1A is a schematic diagram illustrating an embodiment of a heat actuated magnetic latching microswitch in accordance with an embodiment of the invention. The heat actuated microswitch 100 comprises a permanent magnet 102 over which a substrate 104 is attached. The permanent magnet can be, for example, any ferromagnetic material with a sufficiently high Curie temperature that has been permanently magnetized. A sufficiently high Curie temperature is one that will allow the heat actuated magnetic latching microswitch to operate in a particular environment. The substrate 104 can be, for example, silicon for a low frequency RF switch (e.g., operating frequencies from approximately DC to approximately 3 gigahertz (GHz) or a ceramic material for a high frequency RF switch (e.g., operating frequencies from approximately DC to approximately 15 GHz). The substrate 104 can be bonded, glued, or otherwise attached to the permanent magnet 102.

Electrodes 106, 108 and 112 are formed on the substrate 104. The electrodes can be a metallic material, such as copper (Cu), gold (Au), aluminum (Al), etc., suitable for making electrical connection with electrical contacts to be described below. The electrode 108 can be referred to as an input electrode and the electrodes 106 and 112 can be referred to as output electrodes. In one example, the heat actuated microswitch 100 is used to switch a radio frequency (RF) input signal from the electrode 108 to either the electrode 106 or the electrode 112. The electrode 108 includes a portion 144 that extends through the substrate 104 and the permanent magnet 102 so that the electrode 108 can be externally electrically connected to an input signal. Similarly, electrodes 106 and 112 include portions 142 and 146, respectively, which extend through the substrate 104 and the permanent magnet 102 so that the electrodes 106 and 112 can be externally electrically connected to other signal conductors. It should be mentioned that there are other ways of connecting to the electrodes 106, 108 and 112, and the manner shown here is merely one example.

The heat actuated microswitch 100 also comprises a support element 116 to which is mounted a cantilever 114. The support element 116 can be formed over the surface of the electrode 108 as shown, or can be otherwise formed over the substrate 104. For example, the electrode 108 need not extend under the support element 116. In this embodiment, the cantilever 114 is pivotally coupled to the support element 116 so that the cantilever 114 may tilt with respect to the support element 116, while the support element 116 and the length of the cantilever 114 defines the arc through which the cantilever 114 rotates. The cantilever 114 can be fabricated from, for example, silicon, or from a metal, such as copper, aluminum, gold, etc.

A contact assembly 170 and a contact assembly 180 are located at the ends of the cantilever 114. The contact assembly 170 comprises a contact 120, a ferromagnetic material 122 and a heater 124. The contact assembly 180 comprises a contact 130, a ferromagnetic material 132 and a heater 134. The contacts 120 and 130 can be any metallic or semi-metallic material that is capable of providing electrical contact with the electrodes 106, 108 and 112. The ferromagnetic material 122 and 132 can be, for example, chromium dioxide (Cr₂O), which possesses a Curie temperature of 113 degrees Celsius (C). Chromium dioxide is chosen as the ferromagnetic material in switching applications that will generally not exceed 100 degrees C. If switching applications require operating temperatures in excess of 100 degrees C., then another material, such as yttrium iron garnet (YIG) (Y₃Fe₅O₁₂), having a curie temperature of 280 degrees C., or magnesium antimonide (MnSb), having a curie temperature of 310 degrees C., can be used as the ferromagnetic material. Further, other ferromagnetic materials may be used.

The heaters 124 and 134 can be, for example, a sheet resistive material comprising tantalum nitride (Ta₂N) with a passivation layer (not shown). The heaters can be on the order of 100 micrometers (μm)×50 μm, and be approximately less than 0.2 μm thick. In this example, an approximately 10 μm thick layer of chromium oxide (Cr₂O) is deposited, or otherwise formed, on the passivation layer (not shown) and forms the ferromagnetic material 122 and 132. The contacts 120 and 130 are formed over the ferromagnetic material 122 and 132, respectively. Alternatively, other heater architectures can be used.

Power is provided to the heaters 124 and 134 by a power source 138 via connections 140. Although the connections 140 are shown as extending through the substrate 104, other connections between the power source 138 and the heaters 124 and 134 are possible. In one example, the power source provides approximately 2 watts (W) to the heaters 124 and 134. A power source providing 2 W can provide a switching time of less than 50 μs and a cycle time of approximately 0.1 millisecond (ms). Alternatively, a power source providing 0.16 W (5 volts and 32 milliamps (mA)) can provide a switching time of approximately 1 ms. However, the switching and cycle times can be varied based on the drive power. The heat actuated microswitch 100 is covered by an enclosure 136 that forms a seal around the cantilever 114 and electrodes 106, 108 and 112.

The heat actuated microswitch shown in FIG. 1A is shown as being latched in a first position, which is arbitrary. In the position shown in FIG. 1A, under ambient temperature conditions, the permanent magnet 102 attracts the ferromagnetic material 122 so that the contact 120 is drawn to and comes into electrical contact with the electrode 108 and the electrode 112. The permanent magnet 102 has sufficient magnetic attraction to the ferromagnetic material 122 to overcome the inertia of the cantilever 114 and the distance separating the permanent magnet 102 and the ferromagnetic material 122. In this first position, the contact 120 causes an electrical connection to be established between the electrodes 108 and 112.

FIG. 1B is a schematic diagram of the heat actuated microswitch of FIG. 1A after transitioning from a first position to a second position. By activating the power source 138 the temperature of the heater 124 and the ferromagnetic material 122 begins to increase. When the temperature of the ferromagnetic material 122 reaches its Curie temperature, it is no longer attracted to the permanent magnet 102. When the ferromagnetic material 122 is no longer attracted by the permanent magnet 102, the magnetic attraction between the ferromagnetic material 132 and the permanent magnet 102 overcomes the inertia of the cantilever 114 and the cantilever 114 begins to tilt. The ferromagnetic material 132 is attracted by the permanent magnet 102 as long as its temperature is lower than its Curie temperature. The magnetic attraction between the ferromagnetic material 132 and the permanent magnet 102 causes the cantilever 114 to tilt and bring the contact 130 into electrical contact with the electrodes 106 and 108. In this manner, an input signal supplied to the electrode 108 can be switched between a first output (electrode 112) and a second output (electrode 106). Once the cantilever 114 begins moving the contact 130 toward the electrodes 106 and 108 as a result of the magnetic attraction between the ferromagnetic material 132 and the permanent magnet 102, the power source 138 is switched off. When power is removed from the heater 124, the ferromagnetic material 122 begins to cool and will fall below the Curie temperature. However, the magnetic attraction between the ferromagnetic material 132 and the permanent magnet 102 will keep the heat activated microswitch latched in the second position, shown in FIG. 1B.

By actuating the power source 138 to supply power to the heater 134, the magnetic attraction between the ferromagnetic material 132 and the permanent magnet 102 can be reduced to cause the cantilever 114 to transition in the opposite direction.

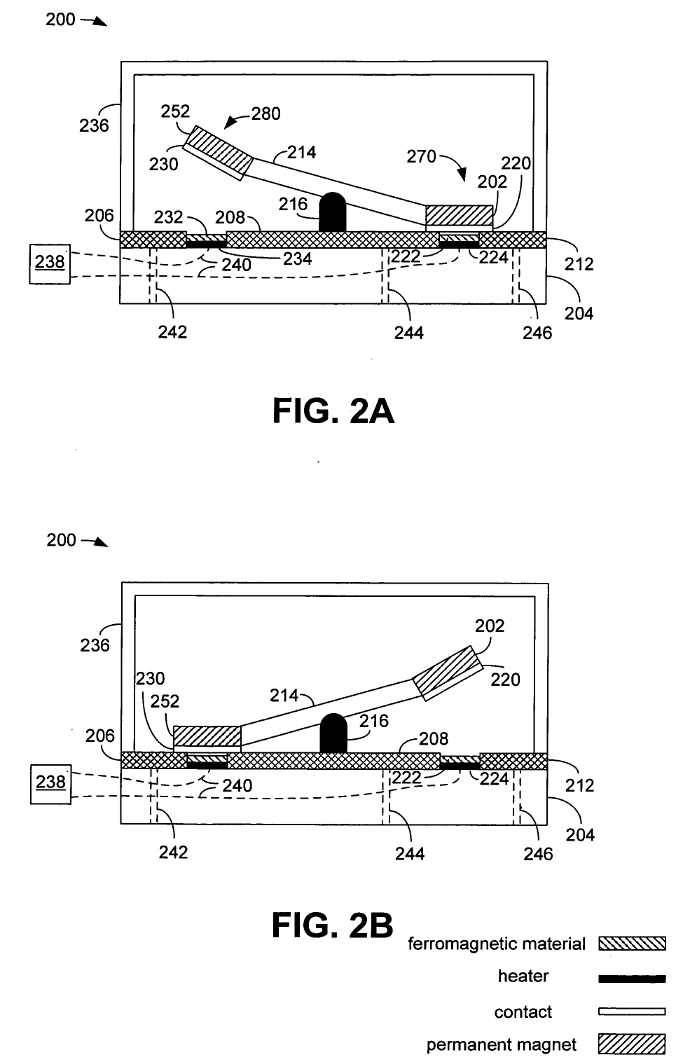

FIG. 2A is a schematic diagram illustrating a heat actuated magnetic latching microswitch in accordance with an alternative embodiment of the invention. The heat actuated microswitch 200 comprises a substrate 204 that is similar to the substrate 104 of FIG. 1A.

Electrodes 206, 208 and 212 are formed on the substrate 204. The electrodes can be a metallic material, such as copper (Cu), gold (Au), aluminum (Al), etc., suitable for making electrical connection with electrical contacts to be described below. The electrode 208 can be referred to as an input electrode and the electrodes 206 and 212 can be referred to as output electrodes. In one example, the heat actuated microswitch 200 is used to switch a radio frequency (RF) input signal from the electrode 208 to either the electrode 206 or the electrode 212. The electrode 208 includes a portion 244 that extends through the substrate 204 so that the electrode 208 can be externally electrically connected to an input signal. Similarly, electrodes 206 and 212 include portions 242 and 246, respectively, which extend through the substrate 204 so that the electrodes 206 and 212 can be externally electrically connected to other signal conductors. It should be mentioned that there are other ways of connecting to the electrodes 206, 208 and 212, and the manner shown here is merely one example.

In this embodiment, heaters 224 and 234 are formed over the substrate 204 in the region between the electrodes. The heater 224 is formed on the substrate 204 in the region between the electrodes 208 and 212, and the heater 234 is formed in the region between the electrodes 206 and 208. The heaters 224 and 234 are similar to the heaters 124 and 134 described above. The heaters 224 and 234 are coupled to a power source 238 via connections 240. The connections 240 are similar to the connections 140 described above. The power source 238 is similar to the power source 138 described above.

A portion of ferromagnetic material 222 is located over the heater 224 between the electrodes 208 and 212. Similarly, a portion of ferromagnetic material 232 is located over the heater 234 between the electrodes 206 and 208. The portions of ferromagnetic material 222 and 232 are similar in characteristics to the ferromagnetic material 122 and 132 described above.

The heat actuated microswitch 200 also comprises a support element 216 to which is mounted a cantilever 214. The support element 216 can be formed over the surface of the electrode 208 as shown, or can be otherwise formed over the substrate 204. For example, the electrode 208 need not extend under the support element 216. In this embodiment, the cantilever 214 is pivotally coupled to the support element 216 so that the cantilever 214 may tilt with respect to the support element 216, while the support element 216 and the length of the cantilever 214 defines the arc through which the cantilever 214 rotates. The cantilever 214 can be fabricated from, for example, silicon, or from a metal, such as copper, aluminum, gold, etc.

A contact assembly 270 and a contact assembly 280 are located at the ends of the cantilever 214. The contact assembly 270 comprises a contact 220 a permanent magnet 202. The contact assembly 280 comprises a contact 230 and a permanent magnet 252. The contacts 220 and 230 are similar to the contact 120 and 130 described above. The permanent magnets 202 and 252 have similar characteristics as the permanent magnet 102 described above.

Power is provided to the heaters 224 and 234 by a power source 238 via connections 240. Although the connections 240 are shown as extending through the substrate 204, other connections between the power source 238 and the heaters 224 and 234 are possible. In one example, the power source 238 provides approximately 2 watts (W) to the heaters 224 and 234. A power source providing 2 W can provide a switching time of less than 50 μs and a cycle time of approximately 0.1 millisecond (ms). However, as mentioned above, the switching and cycle times can be varied based on the drive power. The heat actuated microswitch 200 is covered by an enclosure 236 that forms a seal around the cantilever 214 and electrodes 206, 208 and 212.

The heat actuated microswitch 200 shown in FIG. 2A is shown as being latched in a first position, which is arbitrary. In the position shown in FIG. 2A, under ambient temperature conditions, the permanent magnet 202 attracts the ferromagnetic material 222 so that the contact 220 is drawn to and comes into electrical contact with the electrode 208 and the electrode 212. The permanent magnet 202 has sufficient magnetic attraction to the ferromagnetic material 222 to overcome the inertia of the cantilever 214 and the distance separating the permanent magnet 202 and the ferromagnetic material 222. In this first position, the contact 220 causes an electrical connection to be established between the electrodes 208 and 212.

FIG. 2B is a schematic diagram of the heat actuated microswitch of FIG. 2A after transitioning from a first position to a second position. By activating the power source 238 the temperature of the heater 224 and the ferromagnetic material 222 begins to increase. When the temperature of the ferromagnetic material 222 reaches its Curie temperature, it is no longer attracted to the permanent magnet 202. When the ferromagnetic material 222 is no longer attracted by the permanent magnet 202, the magnetic attraction between the ferromagnetic material 232 and the permanent magnet 252 overcomes the inertia of the cantilever 214 and the cantilever 214 begins to tilt. The ferromagnetic material 232 is attracted by the permanent magnet 252 as long as its temperature is lower than its Curie temperature. The magnetic attraction between the ferromagnetic material 232 and the permanent magnet 252 causes the cantilever 214 to tilt and bring the contact 230 into electrical contact with the electrodes 206 and 208. In this manner, an input signal supplied to the electrode 208 can be switched between a first output (electrode 212) and a second output (electrode 206). Once the cantilever 214 begins moving the contact 230 toward the electrodes 206 and 208 as a result of the magnetic attraction between the ferromagnetic material 232 and the permanent magnet 252, the power source 238 is switched off. When power is removed from the heater 224, the ferromagnetic material 222 begins to cool and will fall below the Curie temperature. However, the magnetic attraction between the ferromagnetic material 232 and the permanent magnet 252 will keep the heat activated microswitch latched in the second position, shown in FIG. 2B.

By actuating the power source 238 to supply power to the heater 234, the magnetic attraction between the ferromagnetic material 232 and the permanent magnet 252 can be reduced to cause the cantilever 214 to transition in the opposite direction.

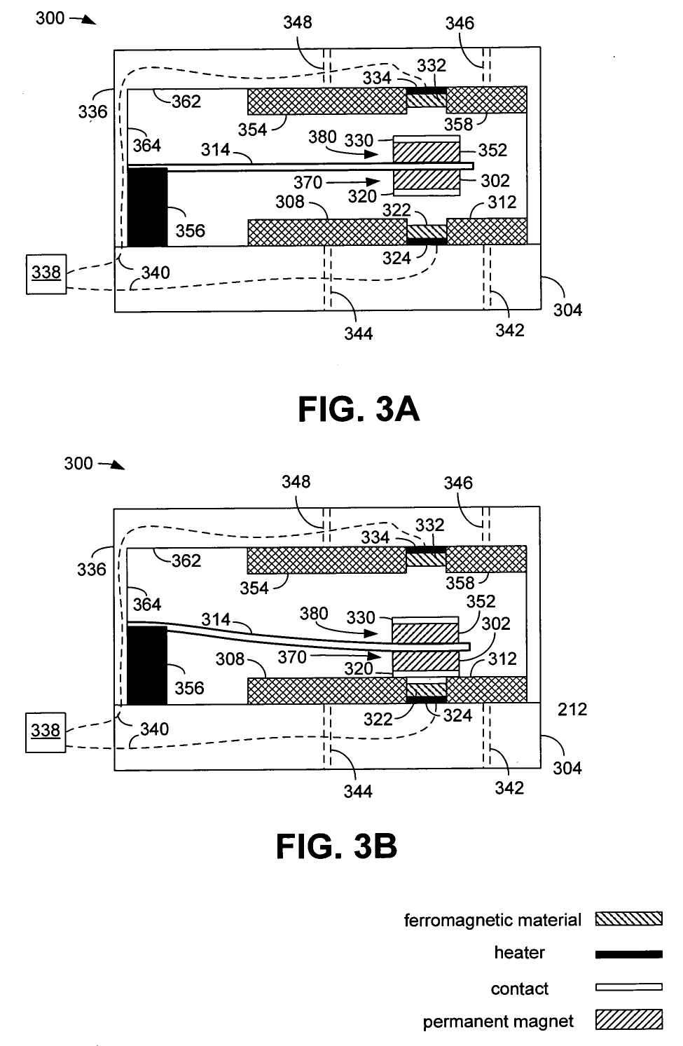

FIG. 3A is a schematic diagram illustrating a heat actuated magnetic latching microswitch in accordance with another alternative embodiment of the invention. The heat actuated microswitch 300 comprises a substrate 304 that is similar to the substrate 104 of FIG. 1A.

Electrodes 308 and 312 are formed on the substrate 304. Electrodes 354 and 358 are formed on a surface 362 of the enclosure 336. The enclosure 336 is similar to the enclosure 136 described above. However, the surface 362 of the enclosure 336 is treated, or has otherwise applied to it, a material over which the electrodes 354 and 358 can be formed, deposited, or otherwise applied. As described above, the electrodes can be a metallic material, such as copper (Cu), gold (Au), aluminum (Al), etc., suitable for making electrical connection with electrical contacts to be described below.

The electrode 308 and the electrode 354 can be referred to as input electrodes and the electrodes 312 and 358 can be referred to as output electrodes. In one example, the heat actuated microswitch 300 is used to switch a radio frequency (RF) input signal from the electrode 308 to the electrode 312 and from the electrode 354 to the electrode 358. The electrode 308 includes a portion 344 that extends through the substrate 304 so that the electrode 308 can be externally electrically connected to an input signal. Similarly, the electrode 312 includes a portion 342 that extends through the substrate 304 so that the electrode 312 can be externally electrically connected to other signal conductors. The electrode 354 includes a portion 348 that extends through the enclosure 336 so that the electrode 354 can be externally electrically connected to an input signal. Similarly, the electrode 358 includes a portion 346 that extends through the enclosure 336 so that the electrode 358 can be externally electrically connected to other signal conductors. It should be mentioned that there are other ways of connecting to the electrodes 308, 312, 354 and 358, and the manner shown here is merely one example.

In this embodiment, a heater 324 is formed over the substrate 304 in the region between the electrodes 308 and 312. A heater 334 is formed on the surface 362 in the region between the electrodes 354 and 358. The heaters 324 and 334 are similar to the heaters 124 and 134 described above. The heaters 324 and 334 are coupled to a power source 338 via connections 340. The connections 340 are similar to the connections 140 described above. The power source 338 is similar to the power source 138 described above.

A portion of ferromagnetic material 322 is located over the heater 224 between the electrodes 308 and 312; Similarly a portion of ferromagnetic material 332 is located over the heater 334 between the electrodes 354 and 358. The portions of ferromagnetic material 322 and 332 are similar in characteristics to the ferromagnetic material 122 and 132 described above.

The heat actuated microswitch 300 also comprises a support element 356 to which is mounted a cantilever 314. The support element 316 can be formed over the substrate 304 as shown, can be formed on the surface 364 of the enclosure 336, or can be otherwise formed to support the cantilever 314. In this embodiment, the cantilever 314 is rigidly coupled to the support element 356, but is fabricated of a flexible material so that the cantilever 314 may deflect with respect to the support element 356. The support element 356, the length of the cantilever 314 and the material from which the cantilever 314 is fabricated defines the arc through which the cantilever 314 moves. The cantilever 314 can be fabricated from, for example, silicon, or from a metal, such as copper, aluminum, gold, etc.

A contact assembly 370 and a contact assembly 380 are located on opposite sides of the cantilever 314 approximately as shown. The contact assembly 370 comprises a contact 320 a permanent magnet 302. The contact assembly 380 comprises a contact 330 and a permanent magnet 352. The contacts 320 and 330 are similar to the contact 120 and 130 described above. The permanent magnets 302 and 352 have similar characteristics as the permanent magnet 102 described above.

Power is provided to the heaters 324 and 334 by a power source 338 via connections 340. Although the connections 340 are shown as extending through the substrate 304 and the enclosure 336, other connections between the power source 338 and the heaters 324 and 334 are possible. In one example, the power source 338 provides approximately 2 watts (W) to the heaters 324 and 334. A power source providing 2 W can provide a switching time of less than 50 μs and a cycle time of approximately 0.1 millisecond (ms). However, as mentioned above, the switching and cycle times can be varied based on the drive power. The enclosure 336 forms a seal around the cantilever 314 and electrodes 308, 312, 354 and 358.

The heat actuated microswitch 300 shown in FIG. 3A is shown as being unlatched. However, under normal ambient temperature conditions, the heat actuated microswitch 300 would be latched in either the upper position, in which the permanent magnet 352 is attracted to the ferromagnetic material 332, or in the lower position, in which the permanent magnet 302 is attracted to the ferromagnetic material 322.

For illustration, assume that the heat actuated microswitch is latched in the upper position, in which the attraction between the permanent magnet 352 and the ferromagnetic material 332 causes the contact 330 to come into electrical contact with the electrodes 354 and 358. The permanent magnet 352 has sufficient magnetic attraction to the ferromagnetic material 332 to overcome the inertia of the cantilever 314 and the distance separating the permanent magnet 352 and the ferromagnetic material 332. In this first position, the contact 330 causes an electrical connection to be established between the electrodes 354 and 358.

FIG. 3B is a schematic diagram of the heat actuated microswitch of FIG. 3A after transitioning from a first position to a second position. By activating the power source 338 the temperature of the heater 334 and the ferromagnetic material 332 begins to increase. When the temperature of the ferromagnetic material 332 reaches its Curie temperature, it is no longer attracted to the permanent magnet 352. When the ferromagnetic material 332 is no longer attracted by the permanent magnet 352, the force of the cantilever 314 acts to separate the contact 330 from the electrodes 354 and 358, and the magnetic attraction between the permanent magnet 302 and the ferromagnetic material 322 overcomes the inertia of the cantilever 314. The ferromagnetic material 322 is attracted by the permanent magnet 302 as long as its temperature is lower than its Curie temperature. The magnetic attraction between the ferromagnetic material 322 and the permanent magnet 302 causes the cantilever 314 to deflect and bring the contact 320 into electrical contact with the electrodes 308 and 312. In this manner, an input signal supplied to the electrode 354 is decoupled from the electrode 358 and an input signal supplied to the electrode 308 is coupled to the electrode 312. Once the cantilever 314 begins moving the contact 320 toward the electrodes 308 and 312 as a result of the magnetic attraction between the ferromagnetic material 322 and the permanent magnet 302, the power source 338 is switched off. When power is removed from the heater 334, the ferromagnetic material 332 begins to cool and fall below the Curie temperature. However, the magnetic attraction between the ferromagnetic material 322 and the permanent magnet 302 will keep the heat activated microswitch 300 latched in the second position, shown in FIG. 3B.

By actuating the power source 338 to supply power to the heater 324, the magnetic attraction between the ferromagnetic material 322 and the permanent magnet 302 can be reduced to cause the cantilever 314 to transition in the opposite direction.

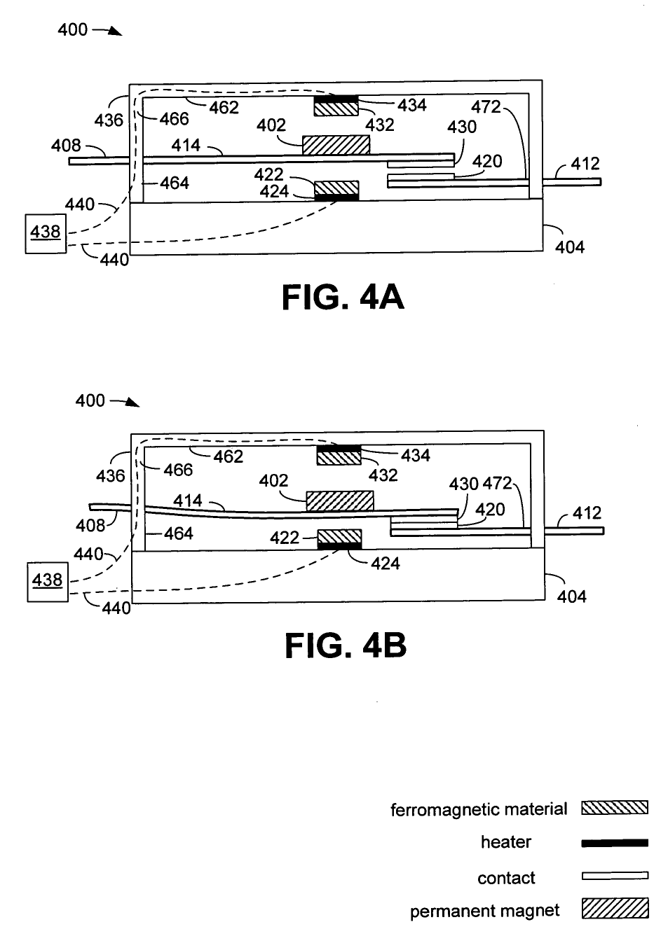

FIG. 4A is a schematic diagram illustrating a heat actuated magnetic latching microswitch in accordance with another alternative embodiment of the invention. The heat actuated microswitch 400 is referred to as a so-called Reed switch. The heat actuated microswitch 400 comprises a substrate 404 that is similar to the substrate 104 of FIG. 1A.

A first electrode 408 is formed on an end of the cantilever 414. The cantilever 414 is similar to the cantilever 314 described above. A second electrode 412 is formed on an end of a contact support 472. The contact support 472 also locates the contact 420, which is similar to the contact 120 described above. Electrodes 308 and 312 are formed on the substrate 304.

In this embodiment, a heater 424 is formed over the substrate 404 approximately as shown. A heater 434 is formed on the surface 462 of the enclosure 436. The enclosure 436 is similar to the enclosure 136 described above. However, the surface 462 of the enclosure 436 is treated, or has otherwise applied to it, a material over which the heater 434 can be formed, deposited, or otherwise applied.

The heaters 424 and 434 are similar to the heaters 124 and 134 described above. The heaters 424 and 434 are coupled to a power source 438 via connections 440. The connections 440 are similar to the connections 140 described above. The power source 438 is similar to the power source 138 described above.

A portion of ferromagnetic material 422 is located over the heater 424. Similarly a portion of ferromagnetic material 432 is located over the heater 434. The portions of ferromagnetic material 422 and 432 are similar in characteristics to the ferromagnetic material 122 and 132 described above.

The cantilever 414 is coupled through and supported by the wall 466 of the enclosure 436. In this embodiment, the cantilever 414 is rigidly coupled to the wall 466, but is fabricated of a flexible material so that the cantilever 414 may deflect with respect to the wall 466. The length of the cantilever 414 and the material from which the cantilever 414 is fabricated defines the arc through which the cantilever 414 moves. The cantilever 414 can be fabricated from silicon, or from a metal, such as copper, aluminum, gold, etc.

A contact 430 is located on the cantilever 414 approximately as shown. A permanent magnet 402 is located on the opposite side of the cantilever 414 from the contact 430 and is located in the vicinity of the ferromagnetic material 422 and 432, approximately as shown. The permanent magnet 402 has similar characteristics as the permanent magnet 102 described above.

Power is provided to the heaters 424 and 434 by a power source 438 via connections 440. Although the connections 440 are shown as extending through the substrate 404 and the enclosure 436, other connections between the power source 438 and the heaters 424 and 434 are possible. In one example, the power source 438 provides approximately 2 watts (W) to the heaters 424 and 434. A power source providing 2 W can provide a switching time of less than 50 μs and a cycle time of approximately 0.1 millisecond (ms). However, as mentioned above, the switching and cycle times can be varied based on the drive power. The enclosure 436 forms a seal around the cantilever 414 and the contacts 420 and 430.

The heat actuated microswitch 400 shown in FIG. 4A is shown as being open. However, under normal ambient temperature conditions, the heat actuated microswitch 400 would be latched in either the upper position, in which the permanent magnet 402 is attracted to the ferromagnetic material 432, or in the lower position, in which the permanent magnet 402 is attracted to the ferromagnetic material 422.

For illustration, assume that the heat actuated microswitch is latched in the upper position, in which the attraction between the permanent magnet 402 and the ferromagnetic material 432 causes the contact 430 to be separated from the contact 420. The permanent magnet 402 has sufficient magnetic attraction to the ferromagnetic material 432 to overcome the inertia of the cantilever 414 and the distance separating the permanent magnet 402 and the ferromagnetic material 432. In this first position, the separation of the contacts 420 and 430 causes an open electrical connection between the electrodes 408 and 412.

FIG. 4B is a schematic diagram of the heat actuated microswitch of FIG. 4A after transitioning from a first position to a second position. By activating the power source 438 the temperature of the heater 434 and the ferromagnetic material 432 begins to increase. When the temperature of the ferromagnetic material 432 reaches its Curie temperature, it is no longer attracted to the permanent magnet 402. When the ferromagnetic material 432 is no longer attracted by the permanent magnet 402, the force of the cantilever 414 acts to move the contact 430 toward the contact 420. Simultaneously, the magnetic attraction between the permanent magnet 402 and the ferromagnetic material 422 overcomes the inertia of the cantilever 414. The ferromagnetic material 422 is attracted by the permanent magnet 402 as long as its temperature is lower than its Curie temperature. The magnetic attraction between the ferromagnetic material 422 and the permanent magnet 402 causes the cantilever 414 to deflect and bring the contact 430 into electrical contact with the contact 420. In this manner, an input signal supplied to the electrode 408 is coupled to the electrode 412. Once the cantilever 414 begins moving the contact 430 toward the contact 420 as a result of the magnetic attraction between the ferromagnetic material 422 and the permanent magnet 402, the power source 438 is switched off. When power is removed from the heater 434, the ferromagnetic material 432 begins to cool and fall below the Curie temperature. However, the magnetic attraction between the ferromagnetic material 422 and the permanent magnet 402 will keep the heat activated microswitch 400 latched in the second position, shown in FIG. 4B.

By actuating the power source 438 to supply power to the heater 424, the magnetic attraction between the ferromagnetic material 422 and the permanent magnet 402 can be reduced to cause the cantilever 414 to transition in the opposite direction and separate the contacts 420 and 430, thus opening the heat activated microswitch 400.

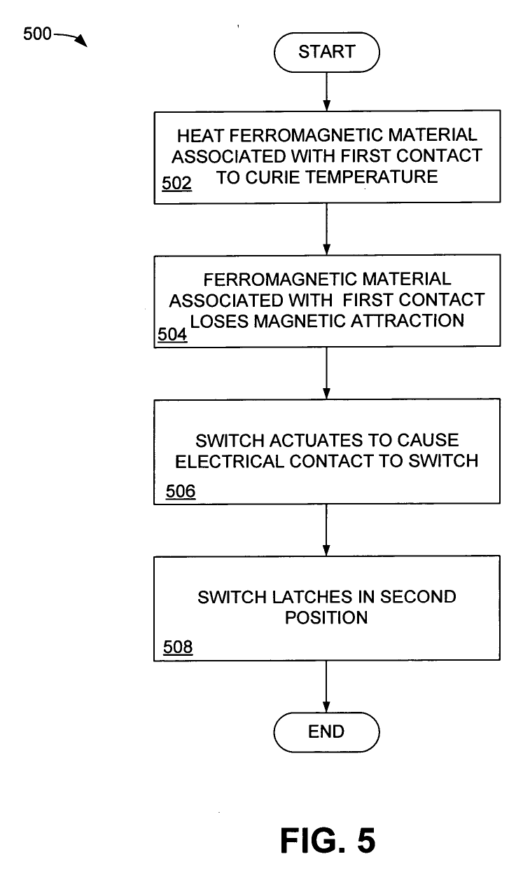

FIG. 5 is a flowchart 500 describing an exemplary method of operating a heat activated microswitch in accordance with an embodiment of the invention. In block 502, it is assumed that a heat actuated microswitch is latched in a first position. A heater in the vicinity of ferromagnetic material is activated to heat the ferromagnetic material to its Curie temperature. In block 504, the ferromagnetic material loses its magnetic attraction after reaching its Curie temperature.

In block 506, the switch actuates to cause electrical contact to be switched. In block 508, the heat activated microswitch latches in a second position.

This disclosure describes the invention in detail using illustrative embodiments. However, it is to be understood that the invention defined by the appended claims is not limited to the precise embodiments described.

What is claimed is:

1. A heat actuated switch, comprising:
a substrate;
a moveable element having at least one electrical contact associated therewith;
a permanent magnet in the vicinity of the electrical contact;
a ferromagnetic material in the vicinity of the permanent magnet and associated with the at least one electrical contact; and
a heater adjacent the ferromagnetic material, whereby actuating the heater alters the magnetic properties of the ferromagnetic material and causes the moveable element to switch the electrical contact.

2. The heat actuated switch of claim 1, further comprising:
a second electrical contact, and wherein the moveable element is a cantilever.

3. The heat actuated switch of claim 1, in which the ferromagnetic material is chosen from chromium dioxide (Cr₂O), yttrium iron garnet (YIG) (Y₃Fe₅O₁₂), and magnesium antimonide (MnSb).

4. The heat actuated switch of claim 2, in which heating the ferromagnetic material above a Curie temperature causes the moveable element to switch the electrical contact.

5. The heat actuated switch of claim 4, in which the heater, the ferromagnetic material and the at least one electrical contact are located at the end of the cantilever.

6. The heat actuated switch of claim 4, in which the permanent magnet and the at least one electrical contact are located at the end of the cantilever and the heater and the ferromagnetic material are located over the substrate.

7. The heat actuated switch of claim 4, in which the permanent magnet and the at least one electrical contact are located on the cantilever and the heater and the ferromagnetic material are located over the substrate and in which the switch functions as a Reed switch.

8. A method for operating a heat actuated switch, comprising:
latching a heat actuated switch in a first position;
heating a first ferromagnetic material to a temperature at which the first ferromagnetic material becomes non-magnetic; and
attracting a second ferromagnetic material using a permanent magnet to cause the switch to latch in a second position.

9. The method of claim 8, in which the ferromagnetic material is chosen from chromium dioxide (Cr₂O), yttrium iron garnet (YIG) (Y₃Fe₅O₁₂), and magnesium antimonide (MnSb).

10. The method of claim 8, in which heating the ferromagnetic material above a Curie temperature causes a moveable element to switch at least one electrical contact.

11. The method of claim 8, further comprising locating the heater, the ferromagnetic material and at least one electrical contact at the end of a cantilever.

12. The method of claim 8, further comprising locating the permanent magnet and at least one electrical contact at the end of a cantilever and locating the heater and the ferromagnetic material over a substrate.

13. The method of claim 8, further comprising locating the permanent magnet and at least one electrical contact on a cantilever and locating the heater and the ferromagnetic material over a substrate and in which the switch functions as a Reed switch.

14. A heat actuated switch, comprising:
a substrate;
a moveable element having at least one electrical contact associated therewith;
a permanent magnet in the vicinity of the electrical contact;
a ferromagnetic material in the vicinity of the permanent magnet and associated with the at least one electrical contact;
a heater adjacent the ferromagnetic material, whereby actuating the heater alters the magnetic properties of the ferromagnetic material and causes the moveable element to switch the electrical contact; and
an enclosure surrounding the moveable element, the at least one electrical contact, the permanent magnet, the ferromagnetic material and the heater.

15. The heat actuated switch of claim 14, further comprising: a second electrical contact, and wherein the moveable element is a cantilever.

16. The heat actuated switch of claim 14, in which the ferromagnetic material is chosen from chromium dioxide (Cr₂O), yttrium iron garnet (YIG) (Y₃Fe₅O₁₂), and magnesium antimonide (MnSb).

17. The heat actuated switch of claim 14, in which heating the ferromagnetic material above a Curie temperature causes the moveable element to switch the electrical contact.

18. The heat actuated switch of claim 17, in which the moveable element switches the at least one contact in approximately 50 microseconds (μs) when 2 (two) watts (W) is applied to the heater.

19. The heat actuated switch of claim 17, in which the moveable element will cycle between two states in approximately 0.1 milliseconds (ms) when 2 (two) watts (W) is applied to the heater.

20. The heat actuated switch of claim 17, in which the moveable element switches the at least one contact in approximately 1 millisecond (ms) when 0.16 W is applied to the heater.
